(19) United States
(12) Patent Application Publication
(10) Pub. No.: US 2011/0218978 A1
(43) Pub. Date: Sep. 8, 2011

(54) OPERATING ON TIME SEQUENCES OF DATA

(75) Inventors: Mingsheng Hong, North Billerica, MA (US); Matthew Fuller, Medfield, MA (US); Hongmin Fan, Malden, MA (US); Shilpa Lawande, Littleton, MA (US)

(73) Assignee: Vertica Systems, Inc., Billerica, MA (US)

(21) Appl. No.: 12/816,822

(22) Filed: Jun. 16, 2010

Related U.S. Application Data
(60) Provisional application No. 61/306,919, filed on Feb. 22, 2010.

(51) Int. Cl. G06F 17/30; G06F 17/00

(52) U.S. Cl. 707/694; 707/792; 707/E17.007; 707/E17.005

(57) ABSTRACT

Methods, systems, and apparatus, including computer programs encoded on a computer storage medium, for operating on time sequences of data. In one aspect, a method includes a database management system storing and updating information in records in a table of a database, the records being associated with respective times that are spaced apart by time intervals, the database management system responding to a query that is phrased to imply a putative record with respect to a time interval that is not among the time intervals with which the records of the table are associated, and the response of the database management system to the query including a computation of a value of an attribute of the putative record from at least one non-null value of the attribute for one of the records of the table, the computation being based on an interpolation policy.

### CROSS-REFERENCE TO RELATED APPLICATION

This application claims the benefit under 35 U.S.C. §119(e) of U.S. Provisional Application No. 61/306,919, filed Feb. 22, 2010, the entire contents of which is incorporated herein by reference.

### BACKGROUND

This description relates to operating on time sequences of data.

In a database table, for example, each record may relate to a corresponding time. If the table contains information about the prices of a particular stock, for example, each record can represent the price of the stock at a particular time. In that instance, a user of the database may find it useful to retrieve and use the sequence of prices as an indicator of the price trend.

### SUMMARY

In general, one innovative aspect of the subject matter described in this specification can be embodied in computer-implemented methods comprising a database management system storing and updating information in records in a table of a database, the records being associated with respective values of an attribute that are spaced apart by attribute intervals, the database management system responding to a query that is posed on behalf of a user and is phrased to imply attribute interval spacings among data items that are different from the attribute interval spacings of the records, the response of the database management system to the query including a generation, by the database management system, of data items having the attribute interval spacings that are implied by the query. Other implementations of this aspect include corresponding systems, apparatus, and computer programs, configured to perform the actions of the methods, encoded on computer storage devices.

These and other implementations can each optionally include one or more of the following features. The attribute is time. The time values with respect to which the records are associated are represented by time stamps in a column of the table. The query states the length of time of the interval spacing of the data items. The time interval spacings of the records are non-uniform. The time interval spacings of the data items are uniform. The generated data items are used by time series functions also implied in the query. The generated data items include values that are interpolated from values in the records of the table. The query implies an ending time for the data items that are generated. The query includes at least one of a WHERE clause and an ORDER BY clause with respect to the data items. The query includes at least one clause that would narrow the number of data items in the response, and the response of the database management system including ordering the evaluation of clauses so as to minimize a number of data items generated. The response of the database management system includes ordering the evaluation of clauses so as to minimize a number of data items generated. The records in the table being stored in multiple database management system nodes, and the response of the database management system being distributed among the nodes where the records are stored. The records are stored in the table sorted by their respective times, in a row-wise fashion, in a column-wise fashion, or in a hybrid row-wise and column-wise fashion. The database management system further responding to the query by generating a rounded version of an original time value associated with a record, the rounded version being the same as a beginning time or an ending time of a predefined time slice to which the time value belongs.

In general, another innovative aspect of the subject matter described in this specification can be embodied in computer-implemented methods comprising a database management system storing and updating information in records in a table of a database, the records being associated with respective times that are spaced apart by time intervals, the database management system responding to a query that is phrased to imply a putative record with respect to a time interval that is not among the time intervals with which the records of the table are associated, the response of the database management system to the query including a computation of a value of an attribute of the putative record from at least one non-null value of the attribute derived from evaluating an expression, the computation being based on an interpolation policy. Other implementations of this aspect include corresponding systems, apparatus, and computer programs, configured to perform the actions of the methods, encoded on computer storage devices.

These and other implementations can each optionally include one or more of the following features. The expression is an attribute of a record in a table of a database. The table is an event-series table. The respective times associated with the records are expressed as timestamps, integers, floating point numbers, dates, or times. The interpolation policy is based on a most recent value of the attribute. The interpolation policy is based on a linear computation with respect to values of the attribute. Partitioning results by the values of one or more of the attributes. Computation of a value of a second attribute of the putative record from at least one non-null value of the second attribute for one of the records of the table, the computation being based on a second interpolation policy. The computation of the value of the attribute, for the entire response, spans an amount of time that is linearly proportional to a number of records in the table. The query includes at least one clause that would further narrow the number of data items in the result, and the response of the database management system further comprising ordering the evaluation of clauses so as to minimize the number of attribute values computed. The records in the table being stored in multiple database management system nodes, and the response of the database management system being calculated in a distributed fashion at the nodes where the records are stored. The records are stored in the table sorted by their respective times, in a row-wise fashion, in a column-wise fashion, or in a hybrid row-wise and column-wise fashion.

In general, another innovative aspect of the subject matter described in this specification can be embodied in a computer-implemented method comprising a database management system storing and updating information in records in a table of a database, the records being associated with respective values of a sequence attribute that are spaced apart by attribute intervals, the database management system responding to a query that is phrased to imply a putative record with respect to a sequence attribute interval that is not among the attribute intervals with which the records of the table are associated, the response of the database management system to the query including a computation of a value of a data attribute of the putative record from at least one non-null value of the data attribute for one of the records of the table, the computation being based on an interpolation policy. Other implementations of this aspect include corresponding systems, apparatus, and computer programs, configured to perform the actions of the methods, encoded on computer storage devices.

In general, another innovative aspect of the subject matter described in this specification can be embodied in a computer-implemented method comprising: in a database management system, parsing, in a database query, a query block that specifies (a) at least one time series function to be performed with respect to a table that includes records that are associated with respective times that are spaced apart by time intervals, and (b) a time series preparation operation to be performed prior to performing the time series function, the query block identifying a length of a uniform time interval for data items, the uniform time interval being different from at least one of the time intervals by which the records of the table are spaced apart. Other implementations of this aspect include corresponding systems, apparatus, and computer programs, configured to perform the actions of the methods, encoded on computer storage devices.

These and other implementations can each optionally include one or more of the following features. The timeseries function identifies first values or last values. The timeseries function determines an average, a minimum, a maximum, a sum, or a count. There is more than one timeseries function specified in the query block. The timeseries function is specified as part of a SELECT clause. The time series preparation operation in a clause that is executed immediately before a SELECT. The query block specifies the time series preparation operation in a clause that is executed after a FROM. The time series preparation operation comprises at least one of interpolation and gap filling. The time series preparation operation is performed at least in part using a computed expression. A result of the timeseries function is returned using an alias.

In general, another innovative aspect of the subject matter described in this specification can be embodied in a computer-implemented method comprising using a database management system to store and update information in records in a table of a database and to retrieve information from the records in response to a query posed on behalf of a user, the records being associated with respective times that are spaced apart by time intervals, the database management system responding to a query that is phrased to invoke a time series aggregate function to be performed with respect to data items that are related to records of the table and are spaced uniformly with respect to time. Other implementations of this aspect include corresponding systems, apparatus, and computer programs, configured to perform the actions of the methods, encoded on computer storage devices.

These and other implementations can each optionally include one or more of the following features. The time series aggregate function returning the first value of a data attribute that is present in a given time slice. The time series aggregate function returning the last value of a data attribute that is present in a given time slice. The time series aggregate function returning the average value of a data attribute for a given time slice. The database management system further responding to a query that is phrased to invoke a second time series aggregate function to be performed with respect to data items that are related to the records of the table, in which the two time series aggregate functions are different.

In general, another innovative aspect of the subject matter described in this specification can be embodied in a computer-implemented method comprising using a database management system to store and update information in records in a table of a database and to retrieve information from the records in response to a query posed on behalf of a user, the records being associated with respective values of a sequence attribute that are spaced apart by attribute intervals, the database management system responding to a query that is phrased to invoke a series aggregate function to be performed with respect to data items that are related to records of the table and are spaced uniformly with respect to the sequence attribute. Other implementations of this aspect include corresponding systems, apparatus, and computer programs, configured to perform the actions of the methods, encoded on computer storage devices.

In general, another innovative aspect of the subject matter described in this specification can be embodied in A computer-implemented method comprising using a database management system to store and update information in records in at least two tables of a database and to process information from the records in response to a query posed on behalf of a user, the records of each of the tables being associated with respective times that are spaced apart by time intervals, the database management system responding to a query that is phrased to invoke a join of records of the two tables, the response of the database management system to the query including consideration of relative times associated with records of the two tables. Other implementations of this aspect include corresponding systems, apparatus, and computer programs, configured to perform the actions of the methods, encoded on computer storage devices.

These and other implementations can each optionally include one or more of the following features. The consideration of the relative times being based on an interpolation policy. The interpolation policy is based on the most recent value of the attribute. The interpolation policy is based on a linear computation with respect to values of the attribute.

In general, another innovative aspect of the subject matter described in this specification can be embodied in a computer-implemented method comprising using a database management system to store and update information in records in at least two tables of a database and to process information from the records in response to a query posed on behalf of a user, the records of each of the tables being associated with respective values of a sequence attribute that are spaced apart by attribute intervals, the database management system responding to a query that is phrased to invoke a join of records of the two tables, the response of the database management system to the query including consideration of relative values of the sequence attribute associated with records of the two tables. Other implementations of this aspect include corresponding systems, apparatus, and computer programs, configured to perform the actions of the methods, encoded on computer storage devices.

In general, another innovative aspect of the subject matter described in this specification can be embodied in a computer-implemented method comprising using a database management system to store and update information in records in a table of a database, the records having respective values of a sequence attribute that enable the records to be ordered based on the values, the database management system responding to a query that implies a partitioning of the records based on an analytic function to be applied to values of a data attribute of the records, the analytic function comprising evaluating a logical expression using, at least in part, the values of the data attribute to obtain a result. Other implementations of this aspect include corresponding systems, apparatus, and computer programs, configured to perform the actions of the methods, encoded on computer storage devices.

These and other implementations can each optionally include one or more of the following features. Comparing the result to a previous result obtained in a previous evaluation of the expression using values of a data attribute from another record of the table, and in which the partitioning of the records is based on the comparison of the result to the previous result. The partitioning of the records is based on the result. The analytic function is configured to partition the records based on user identification data and browsing data, and the partitioning is adaptive based on the browsing data for a user identified by the user identification data. The analytic function is configured to partition the records based on user identification data and browsing data, and the partitioning is adaptive based on a determination of a website being viewed. The analytic function is configured to partition the records based on user identification data and browsing data, and the partitioning is adaptive based on a determination of what time of day the browsing is occurring.

Particular implementations of the subject matter described in this specification can be implemented to realize one or more of the following advantages. Processing time and required storage space, and disk and network input/output operations can be reduced by the integration of time-series analysis with other core database functionality inter alia. Syntax learning time by developers can be reduced, code can be simplified, and development can be more efficient. The flexibility of the functionality can be increased and the processing time required for its execution can be reduced.

Other features, aspects, and advantages of the subject matter will become apparent from the description, the drawings, and the claims.

### BRIEF DESCRIPTION OF THE DRAWINGS

FIG. 1 is a block diagram of an example system for executing certain implementations.

FIG. 2 is a block diagram of an example Database Management System (DBMS) compatible with certain implementations.

FIG. 3 is flow chart of an example technique for performing time series analysis on input data in accordance with certain implementations.

FIG. 4 is a graph and tables of data items illustrating interpolation for time series analysis performed according to certain implementations.

FIG. 5A is a graph and tables of data items illustrating interpolation for time series analysis performed according to certain implementations.

FIG. 5B is a graph of data items illustrating application of multiple time series functions on a set of data.

FIG. 6 illustrates graphs of data items illustrating the handling of NULL values according to certain implementations.

FIG. 7 is a flow chart of an example technique for performing time series outer joins according to certain implementations.

FIG. 8 is a flow chart of an example technique for performing event-based windowing according to certain implementations.

FIG. 9 is a flow chart of an example technique for performing event-based windowing according to certain other implementations.

Like reference numbers and designations in the various drawings indicate like elements.

### DETAILED DESCRIPTION

In some implementations, the techniques described below are used in a relational database management system (DBMS), such as the DBMS called Vertica® and available from Vertica Systems Inc. of Billerica, Mass. The techniques can also be applied on a wide variety of other DBMS and other database systems including column-oriented databases, row-oriented databases and hybrid column and row-oriented databases, as well as other platforms.

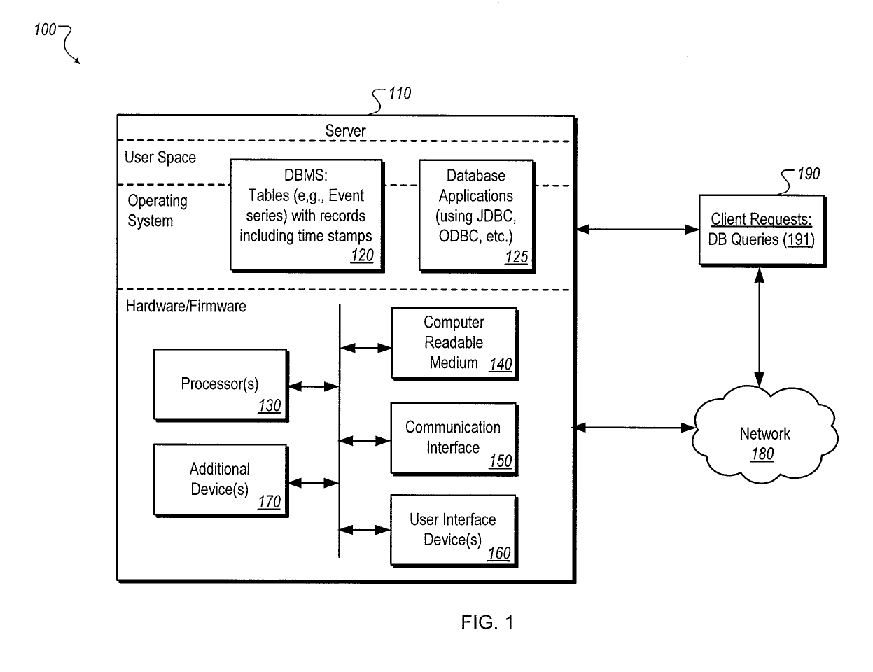

FIG. 1 is a diagram of an example system 100 configured to perform the methods of certain implementations described herein. The system generally consists of a server 110. The server 110 receives queries originating from one or more client devices 190 by way of network 180 (e.g., the Internet). These queries can arrive through a variety of intermediaries, including via usage of low-level client functionality provided by the DBMS 120 itself, or via certain database applications 125 using connection technologies such as Java Database Connectivity (JDBC) or Open Database Connectivity (ODBC). The server 110 consists of one or more data processing apparatus. While only one data processing apparatus is shown in FIG. 1, multiple data processing apparatus can be used. In addition, the DBMS 120 can be distributed over any number of data processing apparatus (known in some implementations as nodes) or even distributed over a “cloud” of loosely coupled computers, including in some instances distribution of the data of the database tables across multiple nodes or throughout the “cloud.” No specific connection between a DBMS installation and a particular server, or number of servers, is required. The server 110 includes various modules, e.g. executable software programs, including the DBMS 120 and optionally various server-side portions of database applications 125 accessing the DBMS via connection technologies such as JDBC or ODBC.

For the purposes of the implementations discussed herein, a DBMS comprises databases (which store data) and functionality which can be performed on the databases. For example, in a relational DBMS, databases as a storage means comprise one or more tables in which the data is arranged in rows and columns. The DBMS additionally comprises functionality that manages the storage of the data, including for example managing the disk input/output (I/O) and network I/O of the data while maintaining the integrity of the databases. DBMSs provide additional functionality for entering data into the various databases, and querying the databases for data at user request Such functions that are implemented within the DBMS (or, natively to the DBMS) are generally faster and more efficient. If a user wishes to perform additional functions on the queried data that are not available natively within the DBMS, the data from the query must be exported, which typically incurs disk I/O and/or network I/O costs, and frequently must be imported into another tool that can perform the desired function, incurring additional costs. It is preferable to use native DBMS functionality where it is available. The provision of DBMS-native functionality related to time series analysis is an advantage of certain implementations described herein.

Each module runs as part of the operating system on the server 110, runs as an application on the server 110, or runs as part of the operating system and part of an application on the server 110, for instance. Although several software modules are illustrated, there may be fewer or more software modules. Moreover, the software modules can be distributed on one or more data processing apparatus connected by one or more networks or other suitable communication mediums, or connected via a “cloud” arrangement.

The server 110 also includes hardware or firmware devices including one or more processors 130, one or more additional devices 170, a computer readable medium 140, a communication interface 150, and one or more user interface devices 160. Each processor 130 is capable of processing instructions for execution within the server 110. In some implementations, the processor 130 is a single or multi-threaded processor. Each processor 130 is capable of processing instructions stored on the computer readable medium 140 or on a storage device such as one of the additional devices 140. The server 110 uses its communication interface 150 to communicate with one or more other computers, for example, over a network 180. Examples of user interface devices 160 include a display, a camera, a speaker, a microphone, a tactile feedback device, a keyboard, and a mouse. The server 110 can store instructions that implement operations associated with the modules described above, for example, on the computer readable medium 140 or one or more additional devices, for example, one or more of a floppy disk device, a hard disk device, an optical disk device, or a tape device.

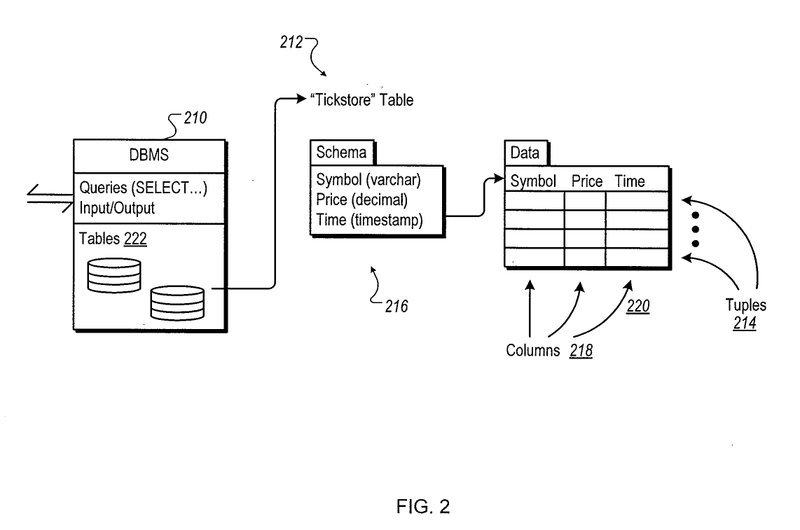

As shown in FIG. 2, in a relational database 210, data 212 is represented by a sequence of tuples 214 stored in tables 222, each table conforming to a particular table schema 216. In some implementations, the data stored comprises time information (indicating, for example, when in time certain events occurred or were observed), where one of the columns 218 stores the time information 220. The column storing time information may use an internal DMBS timestamp data type, or it may use any numerical or date/time data type, including for example integer or decimal.

In some implementations, the data stored comprises other data attributes indicating a sequence, but not necessarily relating to time in particular. Generally, the methods disclosed herein are compatible with the processing of records comprising such sequence data attributes which can be spaced by intervals, whether or not the sequence data is actually indicative of time. Strictly as another example, without limitation, such sequence-indicating attribute could be indicative of locations, separated by intervals of distance.

A Structured Query Language (SQL) table 222 with a column 224 storing time data or other sequence data is an example of what is referred to herein as an event series table. When the phrase event series is used in this description, it very broadly refers to, for example, any series of data in which one aspect of the data is time or sequence information. When such an event series is stored in a database table (hence, event series table), the time or sequence information might be stored as an individual column of data in that table. The time or sequence information need not be of any specific format, but in some implementations could take the form of a database timestamp data type, or any numeric type. The spacing in time, or other sequential measuring dimension, between the various records in an event series need not be uniform and indeed, often will not be uniform. Certain implementations deal specifically with event series tables of source or observed data wherein the time or other sequential spacing between records is not uniform.

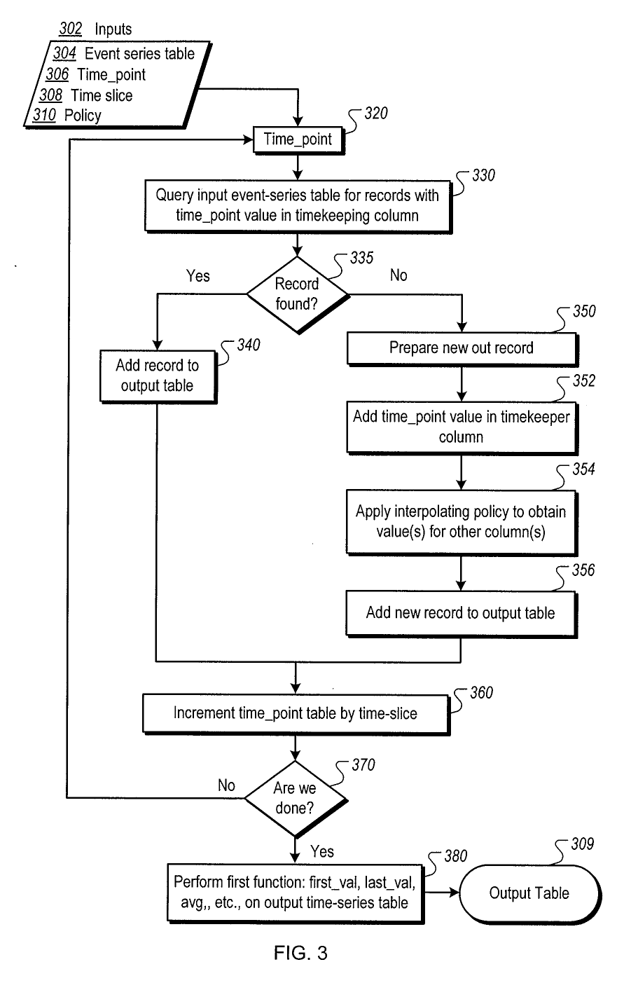

As shown in FIG. 3, some implementations take as inputs 302 an event series table 304, an origin (or starting) time point 306, and a time slice increment 308, and apply, for example, an interpolation policy 310 to produce an output time series table 309, with time values in the time column that are separated by a uniform gap equal to the user-selected time slice increment.

The term “time slice” refers broadly to an increment of time, or an input parameter to certain functions or clauses that specifies an increment of time. In some implementations, input data in the form of an event series will be operated upon to produce output (e.g., in the form of a table of records) having a uniform spacing in time, and the uniform time space between the beginning (or ending) times associated with successive records is specified as a time slice.

This uniformly spaced output will be referred to as a time series, or in the database context, a time series table. A time series broadly refers, for example, to any event series having the additional property that the time spacings between the start times of successive data items is uniform. In a time series table, this might be implemented as a timestamp column whose values are uniformly spaced by an amount equal to a time slice. The time slice, broadly, is the length of time represented by an event of interest in the event series or time series. The time space is the length of time between the start of one event and the start of the next event (or the end of one event and the end of the next. In some implementations, the term “time slice” or variable TIME_SLICE will refer to such amount of time, which is added to an initial point in time in order to determine a sequence of events uniformly spaced in time.

As further illustrated in FIG. 1 above, and as described in more detail with respect to that figure, in some implementations of the computer-implemented method a database query 190 is sent by an end user or, for example, is automatically generated by a piece of middleware (such as JDBC, ODBC, etc) 125, which provides an initialized value 306 representing a point in time, indicated in this figure as time_point 320. The DBMS (illustrated in greater detail at 120) is then used to retrieve 130 an input event-series table 304 for records having time information in the time-storing columns that match the value of time_point.

If one or more records are found, they are copied 340 to an output table 309. If no record is found with the specified time_point value, a new record is generated 350 for inclusion in the output table. Here it should be noted that the output table with output records is, as in typical SQL execution, created in memory at query processing time, and does not impact the data of the original source table. Such implementation has the added benefits that the source data, which may represent direct observation or laborious manual entry, is preserved for future calculations, and also the in-memory output table is available for subsequent calculations, such as may be achieved by nesting the query within other SQL clauses.

The desired time_point value is placed 352 in the time information column of the output record. The values of the data in one or more remaining columns are filled in by the use 354 of, for example, an interpolation policy, or other computational technique. An interpolation policy is, for example, any algorithm or other technique that allows data missing from output records to be filled in based on existing data values of other output records, frequently records that are adjacent or nearby in time sequence. An interpolation policy is often desirable because time series analysis (TSA) functions expect to have data values available for all successive equal length time slices over some longer time period of interest, whereas observed data (e.g., the existing or available event records in an event series) sometimes omits certain time slices or is collected only at irregular intervals or at intervals that are different from the ones implicated by the query. An interpolation policy, for example, allows values to be calculated for a record associated with a given time_point from the values of one or more other records in a corresponding column. Strictly as an example, one such interpolation policy would be to use the value in the respective column for the previous record in terms of time sequence. This and a few other examples of interpolation policies will be described below. Of course, a wide variety of other techniques could be used to generate the new values for the records of the output table.

Once a time_point value has been inserted, and other column values calculated according to an applicable interpolation policy, the output record is added to the output table.

The time_point value is incremented 360 by the time slice increment. A check is performed 370 to determine if the processing of the event series table is complete. The check could take one of several different forms; strictly as examples, the check could assess whether all of the records of the event series table had been processed, or it could assess whether the user had supplied a fixed end time value for the time series, and whether that end time value had been reached. Other completeness checks are possible.

If the check determines that the processing is not complete, then the method continues to process the event series table by using the incremented value for time_point 320. If the processing is complete, then the resulting time series table (which is sometimes also called the output table) is provided for processing by one or more time series analysis functions 380. Such time series analysis functions include, but are not limited to, checking the first value of a given column in a given time slice, checking the last value of a given column in a given time slice, and finding the average value for a given column in a given time slice. A very variety of other time series analysis functions are compatible with various implementations.

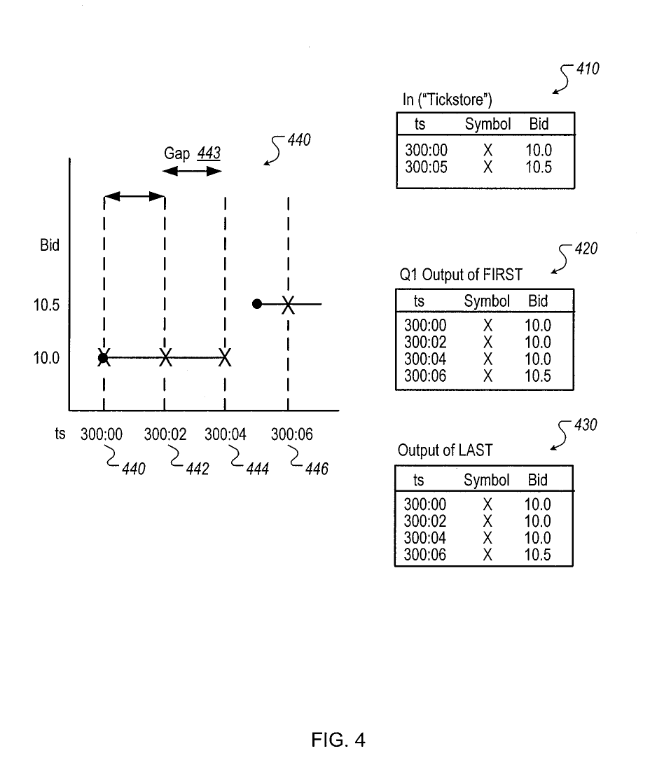

FIG. 4 illustrates features of implementations using examples of input and output data. The following simplified database table schema is used in some of these query examples: Tickstore(symbol, bid, ts), where the name of the table schema is “Tickstore,” and records of this type will contain data in columns named “symbol,” “bid,” and “ts.” The columns' data types are respectively varchar, decimal, and timestamp. A record in this table could indicate a stock quote (in specific, a bid price) for a certain stock ticker symbol at a certain time.

Time is continuous with respect to time series data, which poses certain challenges when evaluating SQL queries over time series data. For example, if the bid price of stock X becomes $10 at 3:00:00 pm, and changes to $10.5 at 3:00:05, then in the Tickstore table, there will be two records representing the above two price changes. These records are indicated in the table at 410 in FIG. 4.

However, between 3:00 pm and 3:00:05, even if there is no tuple for stock X, in many types of time series computation, it may be desirable to obtain the bid price of X at for example 3:00:02. Given a time_point in which there is no input tuple on stock X, an interpolation scheme (or interpolation policy) is used to compute its value, based on the other input tuples. The term interpolation scheme is used broadly herein, as mentioned earlier.

A common interpolation scheme used on financial data is to set the bid price to the last value seen so far. This interpolation scheme is referred to as CONST. In an example under this scheme, the bid price of X remains at $10 between 3 pm and 3:00:05. The content of the Tickstore table is pictorially represented at 440. The x-axis denotes the is column, and the y-axis denotes the bid column. The two solid dots denote the two tuples in Tickstore. The other elements in this figure will be discussed below.

A possible time series analysis function would be to find the first bid value for each (symbol, time slice) combination at 2 second intervals. Let this query be Q1. Its output is listed at 420. Note the first bid value of the second output tuple above: since the bid price of stock X is $10 as of time 3:00:02, the first bid value of the second time slice above, starting at 3:00:02, is 10.0, instead of 10.5. The process of inferring value 10.0 for time 3:00:02 is referred to as interpolation, and the interpolation scheme here is to use the most recent bid value seen on stock X.

This interpolation is visualized in chart 440 as follows. The vertical lines delimit the 2-second time slices. The horizontal lines denote the value of stock X at those time points when there are no input tuples. The “X” marks denote the output of the time slice computation, which lie in the intersections of the vertical lines and the horizontal red lines. Note that the second output tuple above, 442, corresponds to a time slice into which no input tuple falls. Such a time slice is referred to as a gap in the time slices, 443. It is desirable for the output of the computation to fill in the time slice gaps (this is sometimes referred to as gap filling). This implies that the number of output tuples does not necessarily agree with the number of input tuples, and such behavior is outside the domain of traditional analytic functions. Conceptually, gap-filling can be thought of as an example of interpolation, and gap-filling is one part of some exemplary interpolation policies. This gap-filling semantics is pictorially illustrated in chart 440.

Another exemplary time series analysis function that could be performed on exemplary output time series is to obtain the last value of a given column for a given time slice. For the time series indicated in FIG. 4, the result would be as follows 430:

| SLICE_TIME | SYMBOL | LAST_BID |
|---|---|---|
| 3:00:02 | X | 10.0 |
| 3:00:04 | X | 10.0 |
| 3:00:06 | X | 10.5 |

This time series analysis uses the input data shown in 410 and the output indicated here uses the CONST interpolation policy described above.

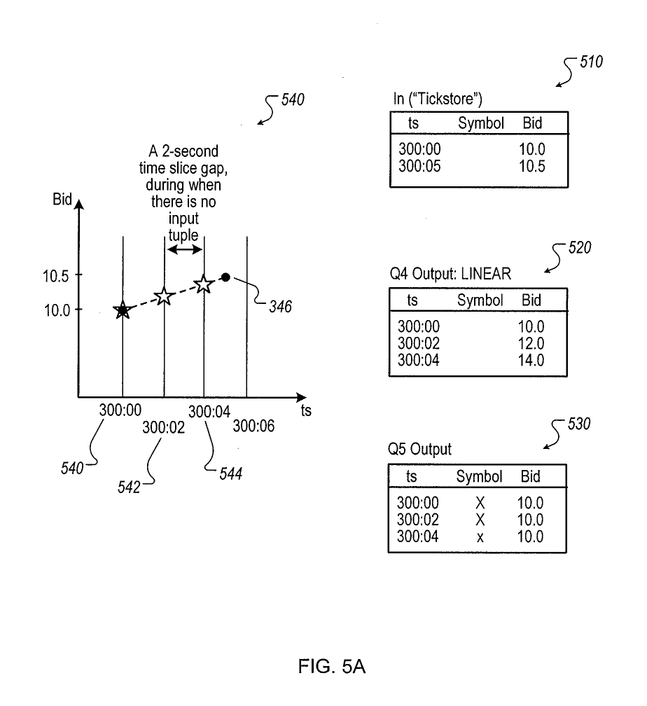

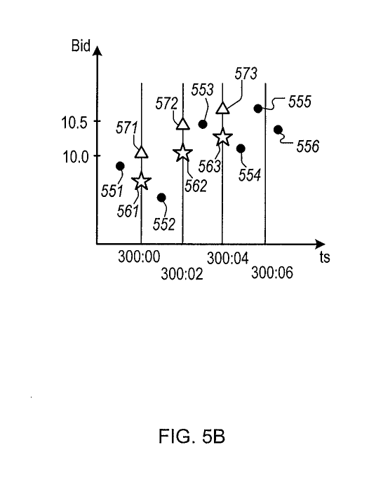

Yet another interpolation policy is depicted in FIG. 5A, and will be referred to as the LINEAR interpolation policy. The LINEAR interpolation policy inserts values in the respective columns of output records that are calculated along a line from the appropriate column value of a previous input record having data in the respective column, and a subsequent input record having data in the respective column. Based on the same input 510 described above and 2-second time slices, the result of first value with linear interpolation is shown in 520. In addition to first value and last value, other functions can be computed on each time slice. For example, the average function with linear interpolation returns the result shown in 530.

In addition to CONST and LINEAR interpolations, a third interpolation scheme compatible with some implementations is NONE, which computes its associated time series analysis function directly on the input tuples belonging to each time slice, without any interpolation. This mode is especially useful for some traditional SQL aggregates such as summation, whose computation results are undefined when the input is interpolated with CONST or LINEAR.

For example, replace the LINEAR interpolation used for the average computation in Q5 (530) with the NONE interpolation. Also, add a second TSA function to the query, which computes summation under NONE interpolation. Let the resulting query be Q6, whose output is as follows:

| SLICE_TIME | SYMBOL | AVG_BID | SUM_BID |
|---|---|---|---|
| 3:00:00 | X | 10.0 | 10.0 |
| 3:00:02 | X | NULL | NULL |
| 3:00:04 | X | 10.5 | 10.5 |

Essentially, the TSA computation on each time slice has the same behavior as its counterpart SQL aggregate computation on the input tuples belonging to that time slice. For both summation and average, the result on an empty set of tuples is NULL, which is reflected in the result of the second time slice computed above, starting at 3:00:02.

Note however for TSA functions such as TS_FIRST_VALUE and TS_LAST_VALUE, the output value of TSA for each time slice gap requires that a specific interpolation scheme, CONST or LINEAR, be used. For example, in FIG. 2, the output value of TS_FIRST_VALUE for the 2-second time slice gap (520, 542) starting at 3:00:02 is only well defined when the interpolation policy is CONST or LINEAR. For those TSA functions, NONE is not a valid interpolation policy. For other traditional SQL aggregates such as summation and average, whose behavior is well-defined on time slice gaps without any interpolation (i.e., aggregating over an empty set of input tuples), NONE is supported for the TSA counterparts of those SQL aggregates.

In various implementations, a new SQL syntax is used to express the interpolation policy. In particular, certain implementations of the claimed methods can be implemented using a TIMESERIES clause in addition to standard SQL queries. The TIMESERIES clause can then be found during parsing of a SQL query and used to invoke appropriate interpolation functions and in turn other time series analytic functions.

Gap filling and interpolation can be the first step for a time series analytics computation. To extend the Tickstore example schema described above, consider additional stock ticker symbols MSFT and IBM, and suppose a user needs to correlate 1 minute of MSFT data with 1 minute of IBM data, but the number of MSFT quotes in the 1-minute window differs from the number of IBM quotes in the 1-minute window. After the interpolation policy has been applied to the input data, the data on MSFT and IBM quotes are made uniform (that is, the time space between sequential records is made uniform), for the subsequent time series analysis function to operate on.

For this purpose, a new SQL clause, TIMESERIES, can be used, for example, to support the application of an interpolation policy together with a SELECT clause in the query. One implementation of such a clause could specify the following pieces of information:

time_expr: An expression that computes the time information of the time series data. In the above queries, this expression is the table column ts. In some implementations this expression is of type timestamp, but more generally, it can be any date/time or numeric type.

length_and_time_unit_expr: The length of time unit of time slice computation.

E₁, . . . , Eₘ (optional): Expressions by which to partition the input time series data. Use of the PARTITION BY clause separates the output into discrete groups that can be treated (e.g., sorted or counted) individually. Certain implementations described herein enable partitioning by expressions, rather than simply by existing database columns. For example, in the above queries, the partitioning expressions are the symbol column and the TIME_SLICE expression.

slice_time: A time column produced as a result of evaluating the TIMESERIES clause, which stores the time slice start times generated from gap filling.

When the TIMESERIES clause is present in a SQL query block, the SELECT clause specifies the following elements.

F₁, . . . , Fₙ: One or more expressions to process the data that belong to each time slice. If PARTITION BY is not specified in TIMESERIES, for each defined time slice, each Fᵢ could produce exactly one output tuple. Otherwise, one output tuple could be produced per partition per time slice. Interpolation is computed there. In the above queries, the first, last, and average bid values are obtained from each time slice. Each Fᵢ may be referred to as a Time Series Aggregate (or TSA) function.

One possible syntax for a SQL query block containing the TIMESERIES clause is as follows.

SELECT F₁, ..., Fₙ, ...
FROM ...
WHERE ...
TIMESERIES slice_time AS length_and_time_unit_expr
OVER ([PARTITION BY E₁, ..., Eₘ] ORDER BY time_expr)

[UNTIL time_expr]

ORDER BY ...

Note that slice_time above is not a new SQL syntax keyword, but an alias. Such a syntax could allow the SQL user to name the output time column of the time slice computation.

Semantically, in some implementations the TIMESERIES clause is evaluated after the FROM and WHERE clauses, and in some instances immediately before the SELECT clause. For a query block containing TIMESERIES, after evaluating the FROM and the optional WHERE clauses, an exemplary computational sequence for evaluating the TIMESERIES and SELECT clauses is as follows:
1. Compute time_expr.
2. Perform the same computation as the TIME_SLICE( ) function on each input tuple based on the result of time_expr and length_and_time_unit_expr. Also perform gap filling to generate time slices missing from the input. Name the result of this computation as slice_time. Essentially, slice_time represents the generated “time series” column after gap filling.
3. Partition the data by E₁, . . . , Eₘ, slice_time. For each partition, do step 4.
4. Sort the data by time_expr. Compute each Fᵢ in F₁, . . . , Fₙ on the sorted data partition (interpolation is done by Fᵢ). The optional UNTIL clause is illustrated below.

By way of illustration, one potential SQL formulation, using TIMESLICE, that might be used to obtain the output of Q1 above is as follows:

SELECT slice_time, symbol, TS_FIRST_VALUE(bid) AS

first bid

FROM Tickstore
TIMESERIES slice_time AS 2 seconds OVER (PARTITION BY

symbol ORDER BY ts);

Note that the TSA function used in Q1, the time series counterpart of the SQL '99 analytic function FIRST_VALUE, has a prefix “TS_” in its name. This prefix naming convention is adopted throughout for exemplary TSA functions.

The semantics of the UNTIL clause may be illustrated based on Q2. When the UNTIL clause is present with time expression E, certain implementations could stop outputting any time slices whose beginning time is greater than E. For example, if the phrase UNTIL ‘3:00:02’ were added to the query formulation of Q1, only one time slice is output as follows.

| SLICE_TIME | SYMBOL | FIRST_BID |
|---|---|---|
| 3:00:00 | X | 10.0 |

As another example, if the phrase UNTIL ‘3:00:09’ were added to Q2, in addition to the three time slices output by Q1, there are additional time slices in the output, as follows.

| SLICE_TIME | SYMBOL | FIRST_BID |
|---|---|---|
| 3:00:00 | X | 10.0 |
| 3:00:02 | X | 10.0 |
| 3:00:04 | X | 10.0 |
| 3:00:06 | X | 10.5 |
| 3:00:08 | X | 10.5 |

Applying LINEAR interpolation would result in padding the output with NULL values for those time slices occurring after the last input time value. More specifically, let the last time value of the input tuples be X, and the UNTIL time value be Y, then for any output time slice whose start time is between X and Y (inclusive), its TSA result is NULL.

For Q3, replace ‘TS_FIRST_VALUE’ with ‘TS_LAST_VALUE’ in the formulation of Q2.

For Q4, which uses linear interpolation, is formulated as follows.

SELECT slice_time, symbol, TS_FIRST_VALUE(bid, ‘LINEAR’)

AS first_bid

FROM Tickstore
TIMESERIES slice_time AS 2 seconds OVER (PARTITION BY

symbol ORDER BY ts);

For Q5, replace TS_FIRST_VALUE(bid, ‘LINEAR’) AS first_bid in Q4 with TS_AVG(bid, ‘LINEAR’) AS avg_bid.

For Q6, replace TS_AVG(bid, ‘LINEAR’) AS avg_bid in Q6 with TS_AVG(bid, ‘NONE’) AS avg_bid, TS_SUM(bid, ‘NONE’) AS sum_bid.

Here is an example of performing time series computation on a time column event id, of type integer. Each time slice spans three consecutive integers. For each time slice, count the number of entries made per user_id.

SELECT slice_id, user_id, TS_COUNT(*) AS cnt
FROM UserActivities
TIMESERIES slice_id AS 3 OVER (PARTITION BY user_id

ORDER BY event_id);

In some implementations, TS_COUNT only works with NONE-interpolation. For each time slice gap, the output of TS_COUNT is 0.

In further implementations, the TIMESERIES clause is integrated in SQL statements with other clauses. Indeed, one advantage offered by certain implementations is an increased efficiency resulting from the integration of time-series analysis alongside other core database functionality. The following example illustrates the use of TIMESERIES together with the SQL WHERE and ORDER BY clauses:

SELECT symbol, slice_time, TS_FIRST_VALUE(bid1) AS

first_bid, TS_FIRST_VALUE(ask1) AS first_ask

FROM Tickstore
WHERE symbol IN (‘MSFT’, ‘IBM’)
TIMESERIES slice_time AS 5 seconds OVER (PARTITION BY

symbol ORDER BY ts)

ORDER BY 1, 2, 4;

In order to perform additional SQL operations before or after the Gap Filling/Interpolation (GFI) computation, such as filtering and aggregation, the interpolation policy computation can be placed in a FROM clause subquery. For example,

SELECT symbol, AVG(first_bid) as avg_bid
FROM
(SELECT symbol, slice_time, TS_FIRST_VALUE(bid1) AS

first_bid

FROM Tickstore WHERE symbol IN (‘MSFT’, ‘IBM’)
TIMESERIES slice_time AS 5 seconds OVER (PARTITION BY

symbol ORDER BY ts)) AS resultOfGFI

GROUP BY symbol;

Note that the WHERE clause predicate in the above query may instead be placed in the outer query block, illustrated in the following formulation.

SELECT symbol, AVG(first_bid) as avg_bid
FROM
(SELECT symbol, slice_time, TS_FIRST_VALUE(bid1) AS

first_bid

FROM Tickstore
TIMESERIES slice_time AS 5 seconds OVER (PARTITION BY

symbol ORDER BY ts)) AS

resultOfGFI
WHERE symbol IN (‘MSFT’, ‘IBM’)
GROUP BY symbol;

While the location of the predicate does not affect the query semantics in this case, it may adversely impact the query performance, if the predicate is evaluated after application of the interpolation policy. As an optimization for the latter case, a database's optimizer module may push the predicate on symbol before the interpolation computation in order to increase efficiency. This optimization may be especially helpful when the subquery of the latter formulation is replaced with a view reference, where the view definition is equivalent to that subquery.

In some implementations, gap filling or interpolation computations can be performed on expressions other than simple table columns.

Suppose a user would like to compute TS_MAX on the input bid column, but the bid column may contain NULL values. Therefore, it would be desirable to first use a row-level function such as NVL(bid, 0) to convert each NULL bid value to 0, and then perform the GFI computation. In certain implementations, the query can then look like:

SELECT slice_time, symbol, TS_MAX(NVL(bid, 0)) AS

first_bid FROM Tickstore TIMESERIES slice_time AS ‘3 seconds’
OVER (PARTITION BY symbol ORDER BY ts);

If the TS_MAX function could only process an input column, as opposed to a more general expression, the query formulation would have to resort to using a subquery to compute NVL. Such a formulation would be more cumbersome, decreasing usability.

Similar query examples can be constructed to show that certain implementations can ORDER BY not only the table column (such as ts), but a more general expression.

One implementation of the TIMESERIES clause may be made to resemble that of the standard SQL '99 WINDOW clause, used to support named windows. However, the similarity is only superficial, to facilitate ease of learning the syntax; the ultimate functionality delivered by the implementations described herein is different from the standard SQL WINDOW clause, as described above and below in detail. In certain implementations, semantic checks can be performed in the TIMESERIES clause to ensure that time_expr is the only ORDER BY expression in the OVER construct, in order to reduce confusion about results ordering.

When there are multiple TSA functions in the SELECT clause, these functions can share the same gap filling policy, defined by the length_and_time_unit_expr parameter together with the OVER construct in the TIMESERIES clause of the same query block. However, the TSA functions can have their individual interpolation schemes and aggregation semantics. The aggregation computation done in a TSA function could be to compute a synopsis value based on all the input tuples in that time slice (e.g. taking the average), to choose a specific input tuple (e.g. taking the first tuple), or via other means. The aggregate computation is entirely encapsulated within the definition of that TSA function.

The following example illustrates that within the same query block, some implementations can support multiple TSA functions, applied to the same or different columns (e.g., bid, ask), with the same or different interpolation policies:

SELECT slice_time, symbol,
TS_FIRST_VALUE(bid, ‘CONST’) AS first_bid_const,

TS_FIRST_VALUE(bid, ‘LINEAR’) AS first_bid_linear,
TS_FIRST_VALUE(ask, ‘CONST’) AS first_ask_const,
TS_LAST_VALUE(bid, ‘CONST’) AS last_bid_const FROM Tickstore
TIMESERIES slice_time AS ‘3 seconds’ OVER (PARTITION BY
symbol ORDER BY ts);

A further illustration of some implementations' support for multiple TSA functions within the same SELECT query block can be found in FIG. 5B. This figure illustrates in graphical form the behavior of the following query.

SELECT slice_time, symbol,
TS_FIRST_VALUE(bid, ‘LINEAR’) AS first_bid_linear,

TS_MAX(bid, ‘LINEAR’) AS max_bid_linear FROM Tickstore
TIMESERIES slice_time AS ‘2 seconds’ OVER (PARTITION BY
symbol ORDER BY ts);

Dots 551-56 represent the input bid values. The stars 561, 562 and 563 and the triangles 571, 572, and 573 represent a selective subset of the output points.

Specifically, the stars 561-63 represent the output values of first_bid_linear in the time points of 3:00:00, 3:00:02 and 3:00:04, while the triangles 571-73 represent the output values of max_bid_linear in the same three time points. Note that the max_bid_linear value time point T represents the maximal interpolated value of bid in the time slice starting at T.

Note that for presentation clarity, multiple TSA were not illustrated in the figure (e.g., functions on different columns, or with different interpolation policies), but such combinations are contemplated within some implementations.

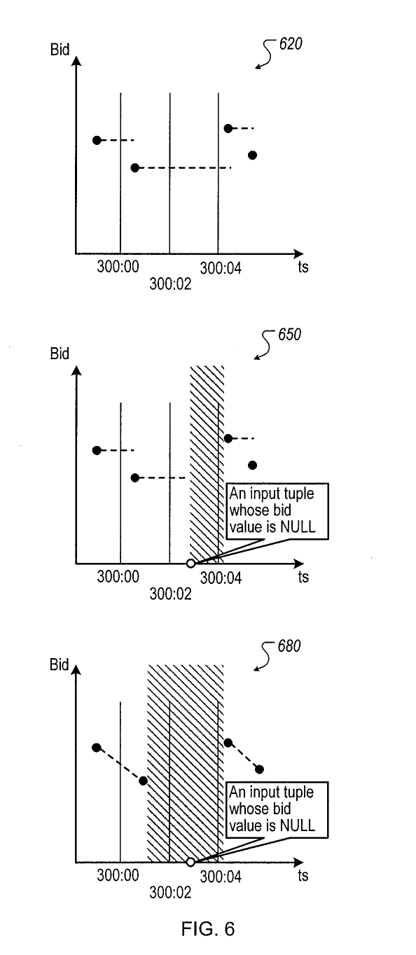

The interpolation policy implementations described thus far have discussed the addition of records for time slices that were not included in the original input data, and various interpolation calculations made in other columns to facilitate this addition. Some implementations address the situation where the input database does contain a record for a given time point, but contains a NULL value in one or more data columns. Some such implementations are illustrated in FIG. 6.

Though null values are not expected to be common in the input event series tables to the interpolation policy computation, interpolation semantics are defined in such cases. For an input tuple with a NULL value in column X that is not ts, let its ts value be t (that is, the tuple/record occurs at time t). In the interpolated result of column X, the X values around time t may be set to NULL.

FIG. 6 illustrates some implementations 620, generally consistent with the CONST interpolation policy described above, and the result on 4 input tuples where there is no NULL value. The same 4 input tuples are present at 650. However, in addition, there is another input tuple whose bid value is NULL, and whose ts value is 3:00:03. It is represented in the figure as a ring. For CONST interpolation, the bid value starting at 3:00:03 becomes NULL, until when we see the next non-NULL bid value in time. In this figure, the presence of the NULL tuple makes the interpolated bid value in the time interval denoted by the shaded region NULL.

Within this implementation, if one were to evaluate TS_FIRST_VALUE(bid) with CONST interpolation on the time slice beginning at 3:00:02, its output is non-NULL. However, TS_FIRST_VALUE(bid) on the next time slice produces NULL, as shown in the shaded portion of the graph 650.

For LINEAR interpolation, the interpolated bid value could become NULL in the time interval denoted by the shaded region in FIG. 6 at 680.

As a result, if we are to evaluate TS_FIRST_VALUE(bid) with LINEAR interpolation on the time slice beginning at 3:00:02, its output is NULL. TS_FIRST_VALUE(bid) on the next time slice remains NULL.

For NONE-interpolation, the NULL behavior is self-explanatory—any NULL values in the input are passed through to the output, but no adjacent rows are affected as no interpolation policy is being applied.

Some implementations are akin to SQL JOIN clauses in relation to event series tables and time-series analysis, referred to here as an “event series join.” An event series join takes two input event series tables, and produces an output event series table. It could be used, for instance, to consolidate the non-timestamp values from both input tables. Of course, such a joined output event series table would be compatible with previously described implementations applying an interpolation policy, to facilitate the use of time series analysis functions.

Similar to standard SQL joins, event series join has INNER and OUTER join modes, which will be described below.

### Semantics

When R joins S with event series join on R.ts1=S.ts2, the output table schema contains all columns in R and S.

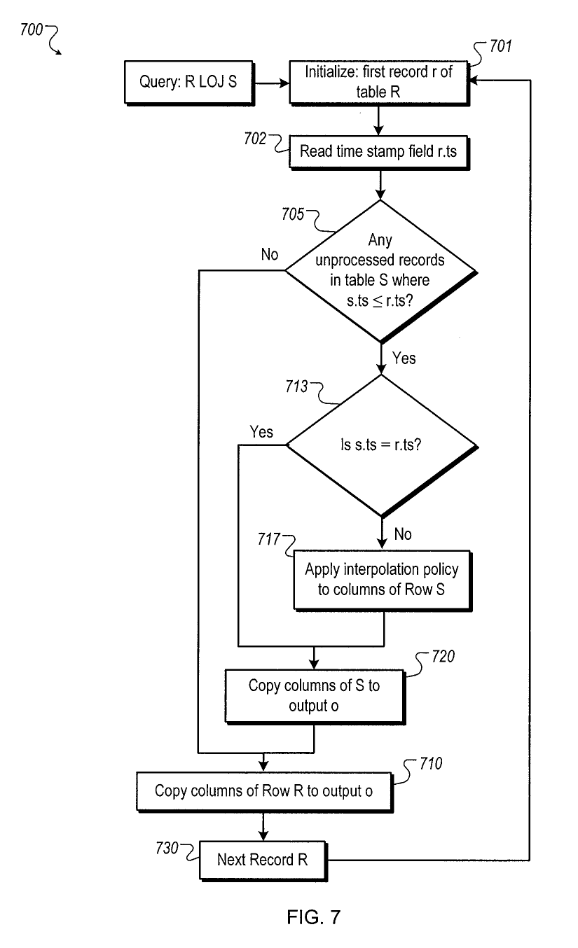

FIG. 7 illustrates an implementation of a method to perform a left outer join on two event series tables. As understood by one of ordinary skill in the art, left and right outer joins are symmetric, and so the functionality of a right outer join is described by this implementation as well. Herein, “left event series outer join” will be abbreviated as LOJ, such that “R left event series outer join S” becomes “R LOJ S” in short. For each tuple r in R where r.ts is non-NULL, there is exactly one tuple in the output, denoted as o, where the values of those columns from R are propagated 710 from t to o. For those columns from S, if there is a tuple s in S with s.ts no greater than r.ts, and s.ts is the largest timestamp value among such tuples, then the column values from s are propagated 720 to o. On the other hand, if there is no such tuple in S, those columns in o coming from S will take NULL values.

Continuing to use the table schema Tickstore(symbol, price, ts) for R and S in the following examples, consider inputs R and S as follows: R={(MSFT, 25.0, 3:00), (MSFT, 25.1, 3:05), (MSFT, 25.2, 3:10)}, and S={(IBM, 120.0, 3:03), (IBM, 120.1, 3:05), (IBM, 120.2, 3:13)}. In the following examples, the ordering of columns in the output is columns from R followed by columns from S.

Then the output of the left event series join is {(MSFT, 25.0, 3:00, NULL, NULL, NULL), (MSFT, 25.1, 3:05, IBM, 120.1, 3:05), (MSFT, 25.2, 3:10, IBM, 120.1, 3:05)}.

Event series join agrees with regular join in that R RIGHT OUTER JOIN S is equivalent to S LEFT OUTER JOIN R.

FULL OUTER JOIN

An additional implementation of a method can perform a full outer join on two event series tables, with interpolation similar to the previously mentioned implementation of left outer joins. Herein, “full event series outer join” will be abbreviated FOJ, such that “R full event series outer join S” will be referred to as R FOJ S. For each unique non-NULL ts value from R and S, there is exactly one tuple propagated into the output, denoted as o. o.ts1=o.ts2=ts. In other words, o.ts1 and o.ts2 are never NULL. This symmetry between o.ts1 and o.ts2 is desirable for the consumer of the output timestamp values, which expects these values to be non-NULL. Otherwise, the consumer has to use a construct such as NVL(o.ts1, o.ts2).

For those columns in o coming from R (other than r.ts1), if there is a tuple r in R with r.ts1 no greater than o.ts, and r.ts1 is the largest timestamp value among such tuples, then the column values from r are propagated to o. Otherwise, those columns in o coming from R will take NULL values. The same semantics applies to those columns coming from S.

Using the same input of R and S described in the previous section, the output of full outer join is {(MSFT, 25.0, 3:00, NULL, NULL, 3:00), (MSFT, 25.0, 3:03, IBM, 120.0, 3:03), (MSFT, 25.1, 3:05, IBM, 120.1, 3:05), (MSFT, 25.2, 3:10, IBM, 120.1, 3:10), (MSFT, 25.2, 3:13, IBM, 120.2, 3:13)}.

INNER JOIN

Herein, “event series inner join” will be abbreviated “IJ,” such that “R event series inner join S” will be referred to as R IJ S. The semantics of event series INNER JOIN is similar to that of regular INNER JOIN. For each non-NULL ts value that occurs in both R and S, there is exactly one tuple in the output. Its column values are set in the same way as was described in FULL OUTER JOIN.

Using the same input of R and S described in the previous section, the output of INNER JOIN is {(MSFT, 25.1, 3:05, IBM, 120.1, 3:05)}.

Note that in some implementations of the event series join semantics, two timestamp attributes are present in the join output (of LOJ, FOJ and IJ). This design is consistent with the semantics of regular joins, and makes R INNER JOIN S symmetric with S INNER JOIN R (this also applies to FULL OUTER JOIN).

When both timestamp columns from R and S have the same name, say ts, and the USING clause is used, the output has one ts column.

Semantics Edge Cases

The input to event series joins may contain a tuple with NULL values, or multiple tuples with identical timestamp values (referred to as duplicate timestamps). Although such input is not expected to be common in practice, since the input tables should be properly “cleaned up” (e.g. via TIMESERIES GFI computation) to remove tuples with NULL values or duplicate timestamps, before an event series join is performed on them. Nevertheless, the semantics should be reasonably defined in these edge cases.

NULL Behavior

Let T be one of the inputs to an event series join, and timestamp column T.ts be part of the join condition. Let r be a tuple in T. If r.ts is NULL, tuple r is ignored (i.e., as if it is filtered out before the event series join). When the NULL value is on a different column, it is treated in the same way as non-NULL values in the join semantics.

Duplicate Timestamps

The semantics is designed to fulfill the following properties.

Cardinality matching for LOJ: For R left event series outer join S, where R has no tuples with R.ts1=NULL, the output has the same number of tuples as R.

Unique timestamp value for FOJ: For R full event series outer join S, there is exactly one output tuple for each unique non-NULL timestamp value that occur in either R or S.

Unique timestamp value for IJ: For R event series inner join S, there is exactly one output tuple for each common non-NULL timestamp value that occur in both R and S.

Case 1: For R LOJ S, if there are two tuples in R, say r1 and r2, with the same timestamp value, there will be one output tuple for each of r1 and r2.

In addition to fulfilling the cardinality matching property, another rationale for the design here is that if duplicate elimination is required, it can always be performed after the event series left outer join. In contrast, if duplicate elimination were “hard-coded” in the join semantics here, the user has does not have an option to “turn it off.”

Case 2: For S in R LOJ S, or S as one of the two input tables to FOJ or IJ, if there are two tuples in S, say s1 and s2, with the same timestamp value, the output tuple o may draw values from either s1 or s2, which creates non-determinism in the output.

For example, say R={((MSFT, 25.1, 3:05)}, and S={(IBM, 120.0, 3:03), (IBM, 120.1, 3:03)}. In this notation, the ordering of columns in the output is columns from R followed by columns from S. Then the output of R left event series outer join S is either {(MSFT, 25.1, 3:05, IBM, 120.0, 3:03)} or {(MSFT, 25.1, 3:05, IBM, 120.1, 3:03)}.

In addition to fulfilling the cardinality matching properties for FOJ and IJ, another rationale here is that given that duplicates may not be eliminated from table R in R LOJ S, it may still be desirable to eliminate duplicates from S, in order to avoid a multiplicative increase in the output size. Otherwise, if R has m tuples at time t, and S has n tuples at t, the output will contain m*n tuples at t.

In some implementations, the event series join computation is expressed in the FROM or WHERE clause, similar to regular joins. Certain implementations enable a new equality operator, #=#, to denote the event series join. e.g.

SELECT ...
FROM R FULL OUTER JOIN S ON R.ts1 #=# S.ts2 ;

This design is consistent with the design of another special type of equality operator that is supported in some implementations, the null equality operator <=>. An alternative design is to introduce new join syntax. e.g.

FROM R INNER|LEFT|RIGHT|FULL EVENTSERIES JOIN S ON R.ts1=S.ts2

For an event series join, some implementations could restrict the join condition, expressed in the ON clause, to be the equality predicate on the timestamp columns in the two input tables.

Event-Based Windows

Event-based windows allow the analyst to break the time-series into windows that border on significant events within the data. This is especially relevant in financial data where analysis tends to focus on specific events as triggers to other activity. Event-based windows are syntactically expressed with new analytic functions, which are introduced below.

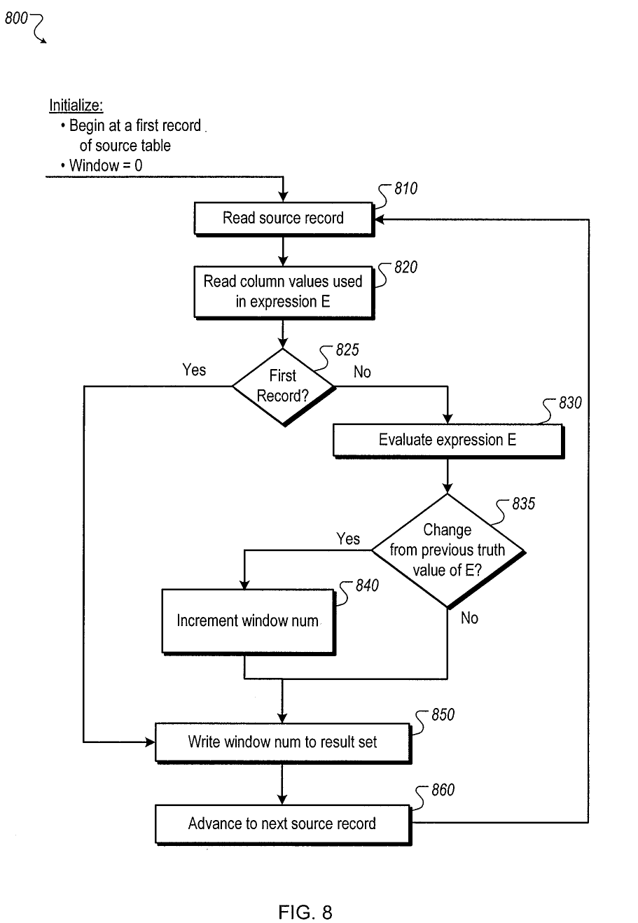

FIG. 8 illustrates one implementation of such an event-based window function, CONDITIONAL_CHANGE_EVENT(E) (“CCE(E)”). CCE is an analytic function that partitions an input sequence of tuples into a sequence of windows, based on the value changes of expression E.

As the semantics of CCE is only well-defined when the input data are sorted, the analytic order by clause is required for CCE. e.g.

SELECT CCE(E) OVER (PARTITION BY symbol ORDER BY ts)

Execution of CCE starts 810 when a record is read from a source database table. Values are read 820 from the columns used in expression E. For the first record only 825, no previous evaluation of E is available for comparison, so evaluation may skip directly to writing the present window number 850. In other cases, the expression E is evaluated 830, and if it has changed from the truth value obtained in the previous evaluation 835, the window number is incremented 840 before being written to the result set 850. In either case, the next source record is loaded 860 and evaluation continues if additional source records remain.

The input expression E is a SQL scalar expression evaluated on an input tuple. The result of E can be of any data type. This exemplary call to the function returns a sequence of integers indicating window numbers, starting from 0. The window number is incremented, when the result of evaluating E on the current tuple differs from that on the previous one.

Example:

SELECT CONDITIONAL_CHANGE_EVENT((ask1 − bid1) >

0.05) OVER (ORDER BY ts)

FROM Tickstore;

In the example, the expression E defined by (ask1−bid1)>0.05 is a Boolean expression. A new window begins whenever the spread, defined by ask1−bid1, goes from equal or below 0.05 to above or vice versa.

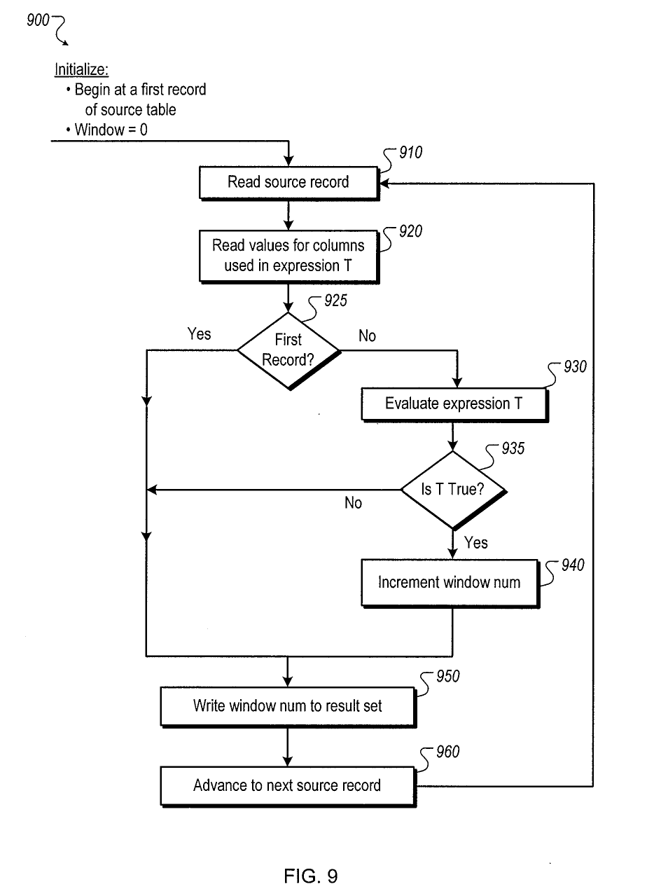

FIG. 9 illustrates another event-based window function CONDITIONAL_TRUE_EVENT (referred to as CTE) that can be supported in a similar way to CCE. CTE(T) defines a new window whenever T is true. For example, given a sequence of values <1, 2, 3, 4> for column X, CTE(X>2) returns <0, 0, 1, 2>. More generally, execution of CTE starts 910 when a record is read from a source database table. Values are read 920 from the columns used in expression T. For the first record only 925, no previous evaluation of T is available for comparison, so evaluation may skip directly to writing the present window number 950. In other cases, the expression T is evaluated 930, and if it is true 935, the window number is incremented 940 before being written to the result set 950. In either case, the next source record is loaded 960 and evaluation continues if additional source records remain.

In the examples of the event-based window functions described so far, the condition expression E or T only accesses values from the current row. A more powerful event-based window would allow the event window condition to be based on change from previous data points. Some implementations use the functional syntax LAG(x, n) to retrieve the value of column X in the nth to last input tuple, as the semantics is the same as the analytic function LAG. The second parameter, n, is optional, and defaults to 1. For example, this expression compares the average value of bid1 and ask1 in the current row with that in the last row: CCE((bid1+ask1)/2−(LAG(bid1)+LAG(ask1))/2>0) OVER (ORDER BY ts).

This usage of LAG can only occur within the expression E of the event-based window. Also, LAG in this case does not have its own OVER clause. It can be viewed as sharing the same OVER clause as its associated event-based window.

Sessionization

Sessionization is a popular feature used in analyzing click streams. It is introduced it in this section as it is a special case of event-based windows. Its semantics is as follows. Given an input clickstream table, where each row records a webpage click made by a particular user (or IP address), the sessionization computation attempts to identify web browsing sessions from the recorded clicks, by grouping the clicks from each user based on the time-intervals between the clicks. Conceptually, if two clicks from the same user are made too far apart in time (as defined by a time-out threshold), they will be treated as coming from two browsing sessions. In the text below, the following table schema is used to represent a clickstream table: webclicks(userId, timestamp).

The standard semantics of sessionization takes a single input parameter: the time-out threshold, which is a constant time interval value. A typical value is 30 seconds. Sessionization performs its computation on two columns in the input clickstream table, the user id and the timestamp of the click.

This formulation of sessionization is however cumbersome. Some implementations introduce a native syntax construct to support the standard form of sessionization. It is a new analytic function, illustrated in the following example.

SELECT SESSIONIZE(timestamp, ‘30 seconds’) OVER

(PARTITION BY userId ORDER BY timestamp)

FROM webclicks;

Any user who is familiar with SQL '99 analytic functions will experience little learning curve in picking up this new function. Also, as a usability enhancement in, certain implementations automatically push down predicates (PPD) on the PARTITION BY columns of analytic functions.

One limitation of the standard form of sessionization above is that the time-out threshold is a constant value. However, different users may have different styles and preferences for internet browsing, and therefore the same time-out threshold may not be able to accurately identify sessions for all users. For example, say user A (identified by the IP address) is a slower web-surfer than average users, perhaps because A is multi-tasking heavily. If an average user does not perform page clicks in a particular web domain D in 30 seconds, it indicates the end of a session. However, for user A, the typical interval between two clicks in same domain is 1 minute, as A is busy tweeting, listening to music, and playing network games at the same time. So one alternative solution, preferable in some circumstances, is to adaptively determine the session timeout threshold of user A based on A's recent browsing behavior (e.g. the average time interval between 2 consecutive clicks in the last 10 clicks which A has performed). This allows us to customize the timeout threshold for difference users.

One method to compute the adaptive time-out threshold based on the last 10 clicks with a “fudge factor” of 3 seconds is to use the following CTE expression instead: CTE (timestamp−LAG(timestamp)<=(LAG(timestamp, 1)−LAG(timestamp,11))/10)+‘3 seconds’

The timeout approximation factor could also be a multiplicative factor instead of an additive one. For example, it can be 110% (of the average time intervals between the last 10 clicks).

Another potential use case for a more sophisticated time-out threshold is to use different threshold values depending on other factors, such as the time of the day, or the part of the web site being browsed. For example, the threshold for a business news website could be higher than a comic strip website, as the articles in the former would take longer to read than the comic strips in the latter.

In some implementations, functionality is provided to normalize the time intervals (time slices) represented by a sequence of time data points in a database into uniform time slices. For example, such functionality could be provided in the context of a database query of a table comprising time data in the database records. If the time data points in a database table are not uniformly spaced, a function could be provided to accept a record's time data point as input, and as a result output the uniform time slice into which the time data point fits. Such function could additionally be configured to provide as output either the beginning time point of the time slice, or the ending time point for the time slice. In a query of the table returning a plurality of records, the outputs of the function over the entire result set would fall on time points that were multiples of the time slice, rather than (or in addition to) the irregularly-spaced time data points stored in the table.

In some implementations, such functionality could be implemented by the addition of a TIME_SLICE clause to the SQL SELECT query. Assuming the following input database table Tickstore:

| Ticker | bid | time |
|---|---|---|
| X | 10.0 | 00:41:01 |
| X | 10.2 | 00:41:16 |
| X | 10.1 | 00:41:33 |

A SELECT query using the TIME_SLICE clause to obtain time points uniformly spaced into 3-second intervals could be structured as:

SELECT Ticker, bid, TIME_SLICE(time, 3) from Tickstore;

And the output would be as follows:

| Ticker | bid | ts |
|---|---|---|
| X | 10.0 | 00:41:00 |
| X | 10.2 | 00:41:15 |
| X | 10.1 | 00:41:33 |

Implementations of the subject matter and the operations described above can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, e.g., one or more modules of computer program instructions, encoded on a computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described.

Other implementations are within the scope of the following claims.

For example, in some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
a database management system storing and updating information in records in a table of a database,
the records being associated with respective values of an attribute that are spaced apart by attribute intervals,
the database management system responding to a query that is posed on behalf of a user and is phrased to imply attribute interval spacings among data items that are different from the attribute interval spacings of the records,
the response of the database management system to the query including a generation, by the database management system, of data items having the attribute interval spacings that are implied by the query.

2. The method of claim 1, in which the attribute is time.

3. The method of claim 2, in which the time values with respect to which the records are associated are represented by time stamps in a column of the table.

4. The method of claim 1, in which the query states the length of time of the interval spacing of the data items.

5. The method of claim 1, in which the time interval spacings of the records are non-uniform.

6. The method of claim 1, in which the time interval spacings of the data items are uniform.

7. The method of claim 1, in which the generated data items are used by time series functions also implied in the query.

8. The method of claim 1, in which the generated data items include values that are interpolated from values in the records of the table.

9. The method of claim 1, in which the query implies an ending time for the data items that are generated.

10. The method of claim 1, in which the query includes at least one of a WHERE clause and an ORDER BY clause with respect to the data items.

11. The method of claim 1, in which the query includes at least one clause that would narrow the number of data items in the response, and
the response of the database management system including ordering the evaluation of clauses so as to minimize a number of data items generated.

12. The method of claim 1, in which the response of the database management system includes ordering the evaluation of clauses so as to minimize a number of data items generated.

13. The method of claim 1, in which the records in the table being stored in multiple database management system nodes, and
the response of the database management system being distributed among the nodes where the records are stored.

14. The method of claim 1, in which the records are stored in the table sorted by their respective times, in a row-wise fashion, in a column-wise fashion, or in a hybrid row-wise and column-wise fashion.

15. The method of claim 2, the database management system further responding to the query by generating a rounded version of an original time value associated with a record, the rounded version being the same as a beginning time or an ending time of a predefined time slice to which the time value belongs.

16. A computer-implemented method comprising:
a database management system storing and updating information in records in a table of a database,
the records being associated with respective times that are spaced apart by time intervals,
the database management system responding to a query that is phrased to imply a putative record with respect to a time interval that is not among the time intervals with which the records of the table are associated,
the response of the database management system to the query including a computation of a value of an attribute of the putative record from at least one non-null value of the attribute derived from evaluating an expression, the computation being based on an interpolation policy.

17. The method of claim 16, in which the expression is an attribute of a record in a table of a database.

18. The method of claim 16, in which the table is an event-series table.

19. The method of claim 16, in which the respective times associated with the records are expressed as timestamps, integers, floating point numbers, dates, or times.

20. The method of claim 16, in which the interpolation policy is based on a most recent value of the attribute.

21. The method of claim 16, in which the interpolation policy is based on a linear computation with respect to values of the attribute.

22. The method of claim 16, further comprising partitioning results by the values of one or more of the attributes.

23. The method of claim 16, further comprising computation of a value of a second attribute of the putative record from at least one non-null value of the second attribute for one of the records of the table, the computation being based on a second interpolation policy.

24. The method of claim 16, in which the computation of the value of the attribute, for the entire response, spans an amount of time that is linearly proportional to a number of records in the table.

25. The method of claim 16, in which the query includes at least one clause that would further narrow the number of data items in the result, and
the response of the database management system further comprising ordering the evaluation of clauses so as to minimize the number of attribute values computed.

26. The method of claim 16, in which the records in the table being stored in multiple database management system nodes, and
the response of the database management system being calculated in a distributed fashion at the nodes where the records are stored.

27. The method of claim 16, in which the records are stored in the table sorted by their respective times, in a row-wise fashion, in a column-wise fashion, or in a hybrid row-wise and column-wise fashion.

28. A computer-implemented method comprising:
a database management system storing and updating information in records in a table of a database,
the records being associated with respective values of a sequence attribute that are spaced apart by attribute intervals,
the database management system responding to a query that is phrased to imply a putative record with respect to a sequence attribute interval that is not among the attribute intervals with which the records of the table are associated,
the response of the database management system to the query including a computation of a value of a data attribute of the putative record from at least one non-null value of the data attribute for one of the records of the table, the computation being based on an interpolation policy.

29. A computer-implemented method comprising:
in a database management system, parsing, in a database query, a query block that specifies (a) at least one time series function to be performed with respect to a table that includes records that are associated with respective times that are spaced apart by time intervals, and (b) a time series preparation operation to be performed prior to performing the time series function, the query block identifying a length of a uniform time interval for data items, the uniform time interval being different from at least one of the time intervals by which the records of the table are spaced apart.

30. The method of claim 29, in which the timeseries function identifies first values or last values.

31. The method of claim 29, in which the timeseries function determines an average, a minimum, a maximum, a sum, or a count.

32. The method of claim 29, in which there is more than one timeseries function specified in the query block.

33. The method of claim 29, in which the timeseries function is specified as part of a SELECT clause.

34. The method of claim 29, in which the query block specifies the time series preparation operation in a clause that is executed immediately before a SELECT.

35. The method of claim 29, in which the query block specifies the time series preparation operation in a clause that is executed after a FROM.

36. The method of claim 29, in which the time series preparation operation comprises at least one of interpolation and gap filling.

37. The method of claim 29, in which the time series preparation operation is performed at least in part using a computed expression.

38. The method of claim 29, in which a result of the timeseries function is returned using an alias.

39. A computer-implemented method comprising:
using a database management system to store and update information in records in a table of a database and to retrieve information from the records in response to a query posed on behalf of a user,
the records being associated with respective times that are spaced apart by time intervals,
the database management system responding to a query that is phrased to invoke a time series aggregate function to be performed with respect to data items that are related to records of the table and are spaced uniformly with respect to time.

40. The method of claim 39, in which the time series aggregate function returning the first value of a data attribute that is present in a given time slice.

41. The method of claim 39, in which the time series aggregate function returning the last value of a data attribute that is present in a given time slice.

42. The method of claim 39, in which the time series aggregate function returning the average value of a data attribute for a given time slice.

43. The method of claim 39, the database management system further responding to a query that is phrased to invoke a second time series aggregate function to be performed with respect to data items that are related to the records of the table,
in which the two time series aggregate functions are different.

44. A computer-implemented method comprising:
using a database management system to store and update information in records in a table of a database and to retrieve information from the records in response to a query posed on behalf of a user,
the records being associated with respective values of a sequence attribute that are spaced apart by attribute intervals,
the database management system responding to a query that is phrased to invoke a series aggregate function to be performed with respect to data items that are related to records of the table and are spaced uniformly with respect to the sequence attribute.

45. A computer-implemented method comprising:
using a database management system to store and update information in records in at least two tables of a database and to process information from the records in response to a query posed on behalf of a user,
the records of each of the tables being associated with respective times that are spaced apart by time intervals,
the database management system responding to a query that is phrased to invoke a join of records of the two tables,
the response of the database management system to the query including consideration of relative times associated with records of the two tables.

46. The method of claim 45, in which the consideration of the relative times being based on an interpolation policy.

47. The method of 45, in which the interpolation policy is based on the most recent value of the attribute.

48. The method of 45, in which the interpolation policy is based on a linear computation with respect to values of the attribute.

49. A computer-implemented method comprising:
using a database management system to store and update information in records in at least two tables of a database and to process information from the records in response to a query posed on behalf of a user,
the records of each of the tables being associated with respective values of a sequence attribute that are spaced apart by attribute intervals,
the database management system responding to a query that is phrased to invoke a join of records of the two tables,
the response of the database management system to the query including consideration of relative values of the sequence attribute associated with records of the two tables.

50. A computer-implemented method comprising:
using a database management system to store and update information in records in a table of a database,
the records having respective values of a sequence attribute that enable the records to be ordered based on the values,
the database management system responding to a query that implies a partitioning of the records based on an analytic function to be applied to values of a data attribute of the records, the analytic function comprising evaluating a logical expression using, at least in part, the values of the data attribute to obtain a result.

51. The method of claim 50 further comprising comparing the result to a previous result obtained in a previous evaluation of the expression using values of a data attribute from another record of the table, and
in which the partitioning of the records is based on the comparison of the result to the previous result.

52. The method of claim 50 in which the partitioning of the records is based on the result.

53. The method of claim 50 in which the analytic function is configured to partition the records based on user identification data and browsing data, and
the partitioning is adaptive based on the browsing data for a user identified by the user identification data.

54. The method of claim 50, in which the analytic function is configured to partition the records based on user identification data and browsing data, and
the partitioning is adaptive based on a determination of a website being viewed.

55. The method of claim 50, in which the analytic function is configured to partition the records based on user identification data and browsing data, and
the partitioning is adaptive based on a determination of what time of day the browsing is occurring.

56. A computer storage medium encoded with a computer program, the program comprising instructions that when executed by data processing apparatus cause the data processing apparatus to perform operations comprising:
a database management system storing and updating information in records in a table of a database,
the records being associated with respective values of an attribute that are spaced apart by attribute intervals,
the database management system responding to a query that is posed on behalf of a user and is phrased to imply attribute interval spacings among data items that are different from the attribute interval spacings of the records,
the response of the database management system to the query including a generation, by the database management system, of data items having the attribute interval spacings that are implied by the query.

57. A computer storage medium encoded with a computer program, the program comprising instructions that when executed by data processing apparatus cause the data processing apparatus to perform operations comprising:
a database management system storing and updating information in records in a table of a database,
the records being associated with respective times that are spaced apart by time intervals,
the database management system responding to a query that is phrased to imply a putative record with respect to a time interval that is not among the time intervals with which the records of the table are associated,
the response of the database management system to the query including a computation of a value of an attribute of the putative record from at least one non-null value of the attribute derived from evaluating an expression, the computation being based on an interpolation policy.

58. A computer storage medium encoded with a computer program, the program comprising instructions that when executed by data processing apparatus cause the data processing apparatus to perform operations comprising:
a database management system storing and updating information in records in a table of a database,
the records being associated with respective values of a sequence attribute that are spaced apart by attribute intervals,
the database management system responding to a query that is phrased to imply a putative record with respect to a sequence attribute interval that is not among the attribute intervals with which the records of the table are associated,
the response of the database management system to the query including a computation of a value of a data attribute of the putative record from at least one non-null value of the data attribute for one of the records of the table, the computation being based on an interpolation policy.

59. A computer storage medium encoded with a computer program, the program comprising instructions that when executed by data processing apparatus cause the data processing apparatus to perform operations comprising:
in a database management system, parsing, in a database query, a query block that specifies (a) at least one time series function to be performed with respect to a table that includes records that are associated with respective times that are spaced apart by time intervals, and (b) a time series preparation operation to be performed prior to performing the time series function, the query block identifying a length of a uniform time interval for data items, the uniform time interval being different from at least one of the time intervals by which the records of the table are spaced apart.

60. A computer storage medium encoded with a computer program, the program comprising instructions that when executed by data processing apparatus cause the data processing apparatus to perform operations comprising:
using a database management system to store and update information in records in a table of a database and to retrieve information from the records in response to a query posed on behalf of a user,
the records being associated with respective times that are spaced apart by time intervals,
the database management system responding to a query that is phrased to invoke a time series aggregate function to be performed with respect to data items that are related to records of the table and are spaced uniformly with respect to time.

61. A computer storage medium encoded with a computer program, the program comprising instructions that when executed by data processing apparatus cause the data processing apparatus to perform operations comprising:
using a database management system to store and update information in records in a table of a database and to retrieve information from the records in response to a query posed on behalf of a user,
the records being associated with respective values of a sequence attribute that are spaced apart by attribute intervals,
the database management system responding to a query that is phrased to invoke a series aggregate function to be performed with respect to data items that are related to records of the table and are spaced uniformly with respect to the sequence attribute.

62. A computer storage medium encoded with a computer program, the program comprising instructions that when executed by data processing apparatus cause the data processing apparatus to perform operations comprising:
using a database management system to store and update information in records in at least two tables of a database and to process information from the records in response to a query posed on behalf of a user,
the records of each of the tables being associated with respective times that are spaced apart by time intervals,
the database management system responding to a query that is phrased to invoke a join of records of the two tables,
the response of the database management system to the query including consideration of relative times associated with records of the two tables.

63. A computer storage medium encoded with a computer program, the program comprising instructions that when executed by data processing apparatus cause the data processing apparatus to perform operations comprising:
using a database management system to store and update information in records in at least two tables of a database and to process information from the records in response to a query posed on behalf of a user,
the records of each of the tables being associated with respective values of a sequence attribute that are spaced apart by attribute intervals,
the database management system responding to a query that is phrased to invoke a join of records of the two tables,
the response of the database management system to the query including consideration of relative values of the sequence attribute associated with records of the two tables.

64. A computer storage medium encoded with a computer program, the program comprising instructions that when executed by data processing apparatus cause the data processing apparatus to perform operations comprising:
using a database management system to store and update information in records in a table of a database,
the records having respective values of a sequence attribute that enable the records to be ordered based on the values,
the database management system responding to a query that implies a partitioning of the records based on an analytic function to be applied to values of a data attribute of the records, the analytic function comprising evaluating a logical expression using, at least in part, the values of the data attribute to obtain a result.

65. A database management system configured to store and update information in records in a table of a database comprising:
a plurality of records associated with respective values of an attribute that are spaced apart by attribute intervals;
means for responding to a query that is posed on behalf of a user and is phrased to imply attribute interval spacings among data items that are different from the attribute interval spacings of the records; and
means for responding to the query including a generation, by the database management system, of data items having the attribute interval spacings that are implied by the query.
